(19) United States
(12) Patent Application Publication
(10) Pub. No.: US 2021/0112947 A1
(43) Pub. Date: Apr. 22, 2021

(54) Charging Make-up Mirror with Multi-level Dimming Function

(71) Applicant: SUPING XIAO, NANNING (CN)

(72) Inventor: SUPING XIAO, NANNING (CN)

(21) Appl. No.: 16/657,418

(22) Filed: Oct. 18, 2019

(51) Int. Cl. A45D 42/10; F21V 23/04; F21V 23/00; F21V 7/00; H02J 7/02; H02J 7/00

(52) U.S. Cl. CPC A45D 42/10; F21V 23/0485; F21V 23/003; F21V 7/00; F21Y 2115/10; H02J 7/025; H02J 7/0068; H02J 7/0052; F21V 23/0435

(57) ABSTRACT

Disclosed is a charging make-up mirror with a multi-level dimming function, comprising a make-up mirror box, wherein the make-up mirror box is composed of a box bottom and a cover which are in hinged fit, and the cover and the box bottom respectively have a built-in main mirror and a built-in inner auxiliary mirror which are opposite to each other. The invention adds the wireless charging and the sliding touch dimming function into the make-up mirror, and a user can conveniently use the wireless charging function of the make-up mirror to charge a device; thus, fragmented time is made to good use and the user feels convenient and comfortable.

### TECHNICAL FIELD

The invention particularly relates to a make-up mirror, and in particular to a charging make-up mirror with a multi-level dimming function.

### BACKGROUND ART

At present, there are many minors on the market that have a fill light function, but they are generally poor in light source, may cause eye soreness and glare or cannot provide enough brightness. They cannot be adjusted to the most appropriate brightness for everyone. At present, mainstream make-up minors available in the market are still plane mirrors, and some also have a magnifying function, and the shape is relatively dull. The mirrors generally have angle limitations.

Moreover, the general make-up minor has a single function structure, and the trivial time of a user using the make-up minor is generally wasted and cannot be effectively utilized. Therefore, for such problems, we need a make-up mirror with more comprehensive functions and capable of adjusting the brightness of the fill light.

### SUMMARY OF THE INVENTION

An object of the invention is to provide a charging make-up mirror with a multi-level dimming function to solve the problems set forth in the background art described above.

To achieve the above objective, the invention provides the following technical solution:

A charging make-up mirror with a multi-level dimming function, comprising a make-up mirror box, wherein the make-up mirror box is composed of a box bottom and a cover which are in hinged fit, and the cover and the box bottom respectively have a built-in main mirror and a built-in inner auxiliary mirror which are opposite to each other; a fill light strip for filling light is disposed around the main minor and provided with a beauty component for beautification; a multi-level touch slider module for adjusting the fill light strip is disposed in the make-up mirror box; a power module for supplying power, a wireless charging module for charging an external smart device and the power module itself, and a main control module are disposed inside the box bottom; a cover opening/closing detecting module for detecting an open/closed state of the cover and the box bottom is disposed in a position where the box bottom and the cover are hinged; a button module to be connected with the main control module is disposed on a surface of the cover; and an input end of the main control module is electrically connected to output ends of the button module, the cover opening/closing detecting module and the multi-level touch slider module.

A further solution: the power module comprises a lithium ion rechargeable battery, a charging management module, a discharging management module, and a charging and discharging arbitration module, wherein the charging and discharging arbitration module is electrically connected to a charging end of the lithium ion rechargeable battery through the charging management module, a discharge end of the lithium ion rechargeable battery is electrically connected to the charging and discharging arbitration module through the discharging management module, and the discharge end of the lithium ion rechargeable battery is electrically connected to the main control module of the main control module and a power supply end of the wireless charging module through the power management module.

A further solution: the wireless charging module comprises a wireless charging driver module, a communication protocol detecting module, and a transmitting coil, a signal end of the wireless charging driver module is electrically connected to an output end of the main control module, a receiving end of the communication protocol detecting module is connected in parallel in a loop of the transmitting coil, and an output end of the communication protocol detecting module is electrically connected to an input end of the main control module.

A further solution: the multi-level touch slider module comprises a capacitive touch gradient-changing button disposed in the make-up mirror box, an output end of the touch gradient-changing button is electrically connected to the input end of the main control module, and the touch gradient-changing button comprises an arced gradient-changing button and a linear gradient-changing button, the touch area of the touch gradient-changing button is increased gradually or reduced gradually or first increased and then reduced, from an initial end to a terminal end.

A further solution: the beauty component comprises an LED using a cold and warm two-color high color rendering index, a diffuse reflection lampshade, a filter coating and a face-lifting main mirror; the LED and the diffuse reflection lampshade constitute a body of the fill light strip; the filter coating is blocked on an outer surface of the diffuse reflection lampshade; the face-lifting main mirror adopts a symmetrical design with a slight depression from the left and right sides to the center, and the face-lifting main mirror is used for the main mirror and the inner auxiliary mirror.

A further solution: a Bluetooth module is disposed in the make-up mirror box, and the Bluetooth module is electrically connected to the main control module through a conversion module, and is mainly configured to implement Bluetooth connection control between a mobile phone and the make-up mirror box.

A further solution: a charging port for single-port USB charging and discharging is disposed on a side wall of the box bottom; the multi-level touch slider module comprises an arc-shaped touch slider disposed on an outer ring of the inner auxiliary mirror; the button module comprises a wireless charging button disposed on the outer top surface of the cover and used for controlling wireless charging; and the output end of the wireless charging button is electrically connected to the input end of the main control module.

A further solution: a power loop of the fill light strip is provided with an anti-flash circuit.

A further solution: the main mirror and the inner auxiliary mirror are arranged as magnifying lenses.

The invention has the following beneficial effects as compared with the prior art.

Ring-shaped and soft fill light is provided without flashing, the light is more uniform, multi-level brightness adjustment is implemented by sliding touch, and the make-up mirror is thus more suitable for various bright environments;

The arrangement of two mirrors provides more minor angles and it is supported to set the minors to have different magnifications to facilitate different minoring effects;

Due to the one-button wireless charging function of the make-up mirror, the user can take good use of the fragmented time when using the minor for putting on makeup, thus enhancing the practical function;

Due to the setting of the automatic opening function, the make-up mirror is easy to operate and convenient for the user.

### BRIEF DESCRIPTION OF THE DRAWINGS

FIG. 1 is a schematic diagram showing the structure of a charging make-up mirror with a multi-level dimming function when it is opened.

FIG. 2 is a schematic diagram showing the structure of the charging make-up mirror with a multi-level dimming function when it is closed.

FIG. 3 is a diagram showing the circuit principle in the charging make-up mirror with a multi-level dimming function when it is opened.

FIG. 4 is a block diagram showing the circuit principle between the chargeable make-up mirror with a multi-level dimming function and an external device terminal when the charging make-up mirror is charged.

FIG. 5 is a diagram showing the circuit principle of a wireless charging driver module in the charging make-up mirror with a multi-level dimming function.

FIG. 6 is a diagram showing the circuit principle of a communication protocol detecting module in the charging make-up mirror with a multi-level dimming function.

FIG. 7 is a diagram showing the circuit principle of an anti-flash circuit in the charging make-up mirror with a multi-level dimming function.

FIG. 8 is a schematic diagram showing the structure of an arced gradient-changing button in the charging make-up mirror with a multi-level dimming function.

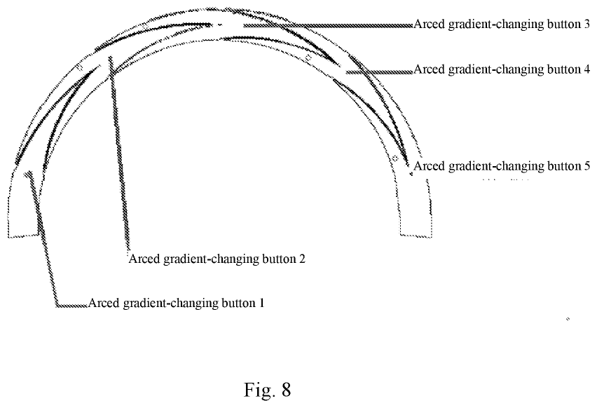

FIG. 9 is a schematic diagram showing the structure of a linear gradient-changing button in the charging make-up mirror with a multi-level dimming function.

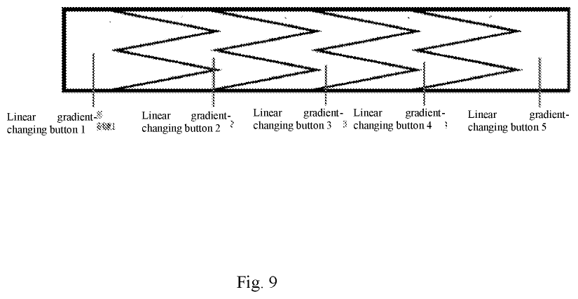

In the figures, box bottom 1; arc-shaped touch slider 10; inner auxiliary mirror 11; charging port 12; cover 2; main mirror 20; fill light strip 21; and wireless charging button 22.

### DETAILED DESCRIPTION

The technical solutions in the embodiments of the invention will be described clearly and completely below in connection with the drawings in the embodiments of the invention, and it will be apparent that the embodiments described here are merely a part, not all of the embodiments of the present application. All other embodiments obtained by those skilled in the art based on the embodiments of the invention without creative efforts shall fall within the scope of the invention.

### Embodiment 1

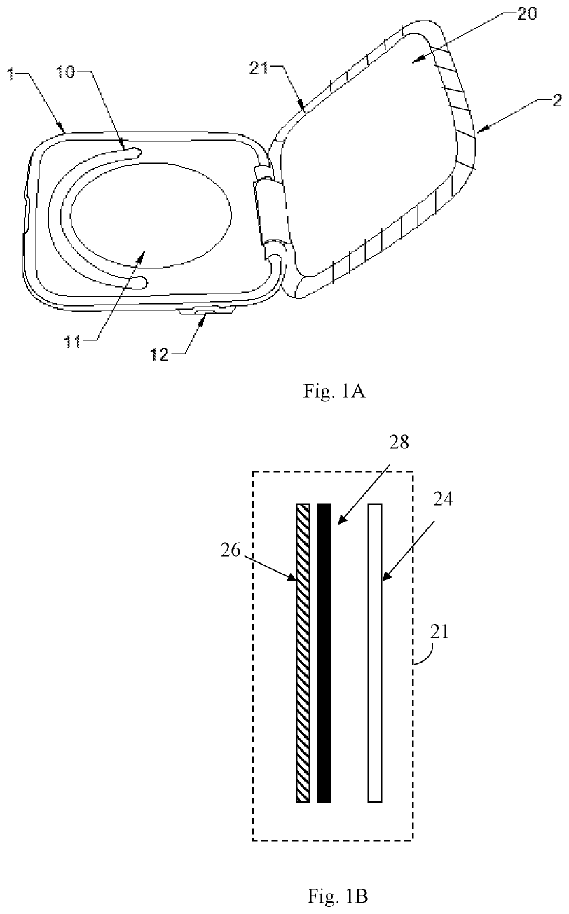

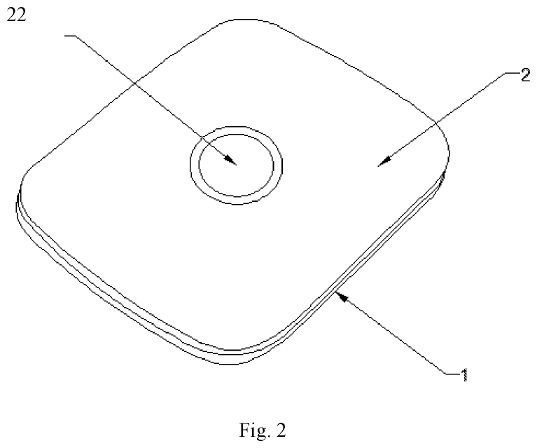

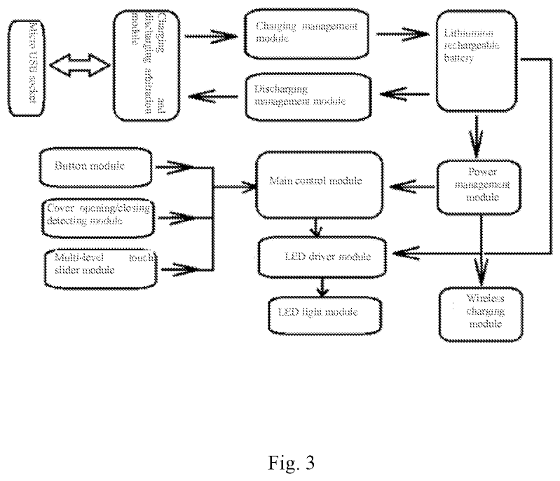

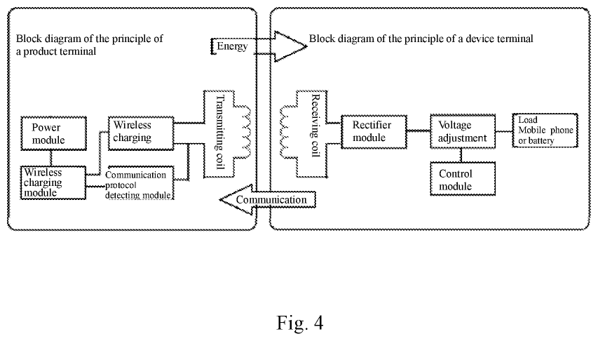

Referring to FIG. 1-FIG. 4, in an embodiment of the invention, disclosed is a charging make-up mirror with a multi-level dimming function, comprising a make-up mirror box, wherein the make-up mirror box is composed of a box bottom 1 and a cover 2 which are in hinged fit, and the cover 2 and the box bottom 1 respectively have a built-in main mirror 20 and a built-in inner auxiliary mirror 11 which are opposite to each other; a fill light strip 21 for filling light is disposed around the main mirror 20 and provided with a beauty component for beautification; a multi-level touch slider module for adjusting the fill light strip 21 is disposed in the make-up mirror box; a power module for supplying power, a wireless charging module for charging an external smart device and the power module itself, and a main control module are disposed inside the box bottom 1; a cover opening/closing detecting module for detecting an open/closed state of the cover 2 and the box bottom 1 is disposed in a position where the box bottom 1 and the cover 2 are hinged; a button module to be connected with the main control module is disposed on a surface of the cover 2; and an input end of the main control module is electrically connected to output ends of the button module, the cover opening/closing detecting module and the multi-level touch slider module.

The power module comprises a lithium ion rechargeable battery, a charging management module, a discharging management module, and a charging and discharging arbitration module, wherein the charging and discharging arbitration module is electrically connected to a charging end of the lithium ion rechargeable battery through the charging management module, a discharging end of the lithium ion rechargeable battery is electrically connected to the charging and discharging arbitration module through the discharging management module, and the discharging end of the lithium ion rechargeable battery is electrically connected to the main control module of the main control module and a power supply end of the wireless charging module through the power management module.

The wireless charging module comprises a wireless charging driver module, a communication protocol detecting module, and a transmitting coil; a signal end of the wireless charging driver module is electrically connected to an output end of the main control module; a receiving end of the communication protocol detecting module is connected in parallel in a loop of the transmitting coil and receives a potential signal during a wireless charging and discharging process through the transmitting coil; the output end of the communication protocol detecting module is electrically connected with the input end of the main control module; in use, the communication protocol detecting module detects and identifies a power supply device in real time, and after the identity authentication, the charging and discharging process is performed. When the make-up mirror box is placed on an external wireless charger, the transmitting coil originally used for external charging becomes a receiving coil and the external charger can wirelessly charge the power module inside the make-up minor box.

The multi-level touch slider module comprises a capacitive touch gradient-changing button disposed in the make-up minor box, an output end of the touch gradient-changing button is electrically connected to the input end of the main control module, and the touch gradient-changing button comprises an arced gradient-changing button and a linear gradient-changing button, the touch area of the touch gradient-changing button is increased gradually or reduced gradually or first increased and then reduced, from an initial end to a terminal end. Multi-level touch means that when a finger moves to the terminal end from the initial end of the slider, the main control module can detect at least 4 and more than four finger touch positions, and the maximum number of finger contact positions that the main control module can detect is not limited and there may be 1024 levels, or even more; the main control module will automatically adjust the brightness of the LED light according to the detected finger touch positions, or adjust other parameters to be adjusted according to the positions.

The beauty component comprises an LED using a cold and warm two-color high color rendering index, a diffuse reflection lampshade, a filter coating and a face-lifting main mirror; the LED and the diffuse reflection lampshade constitute a body of the fill light strip 21; the filter coating is blocked on an outer surface of the diffuse reflection lampshade; the face-lifting main mirror adopts a symmetrical design with a slight depression from the left and right sides to the center, and the face-lifting main mirror is used for the main mirror 20 and the inner auxiliary mirror 11; the arranged LED has a color temperature that can be selected between 2000 k and 6800 k and emits soft warm light, so that the skin looks more lustrous, showing the charm of golden light; the arranged diffuse reflection lampshade is fabricated to have an uneven inner surface, and when light passes through the mirror surface diffuse, diffuse reflection occurs, the light is scattered, a uniform light phenomenon is achieved, and thus the contour of an imaged object is softened with reduced contrast, producing a “soft light” effect; the soft light can avoid glare, produce a hazy facial effect, and cover up tiny wrinkles or stains and acnes on the face, so that the face looks more smooth and radiant; the filter coating is used to filter out blue light and infrared light; and the arranged filter coating is used to filter out blue light and infrared light, so that the light transmitted through the diffuse reflection lampshade remains warm and soft, preventing the face from looking too blue or too red.

The working principle of the invention is as follows: in use, when the cover 2 of the make-up minor box is opened, the cover opening/closing detecting module at the position where the box bottom 1 and the cover 2 are hinged will transmit an open signal to the main control module, and the main control module drives the fill light strip 21 to light up, thus achieving an automatic sensing function; the user can realize the automatic multi-level brightness adjustment of the fill light strip 21 by touching the gradient-changing button; the inner auxiliary mirror 11 on the box bottom 1 can increase the viewing angle, thus bringing more convenience for the user to use the mirror for putting on makeup; the button module activates the charging and discharging function of the box bottom 1, so that the product of the invention can wirelessly charge an external device terminal when the user uses the product to put on makeup, thereby greatly utilizing the fragmented time and increases the practical function of the make-up mirror box. Thus, the invention adds the wireless charging/wireless Charge Pal and the sliding touch dimming functions into the make-up mirror, and a user can conveniently use the wireless charging function of the make-up mirror to charge a mobile terminal device; thus, fragmented time is made to good use, and the user feels convenient and comfortable.

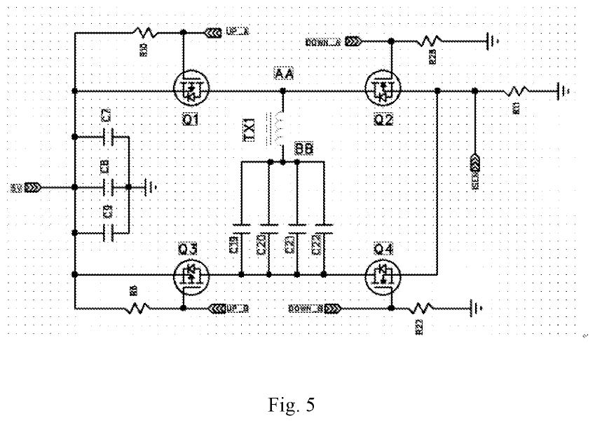

Referring to FIG. 5, the working principle of the wireless charging driver module is as follows:

UP_A, UP_B, DOWN_A, and DOWN_B of control signals from the wireless charging module control the conduction sequence of four MOS transistors Q1, Q2, Q3, and Q4. When Q1 and Q4 are turned on, and Q2 and Q3 are turned off, resonant AC current flows from an AA point of the transmitting coil TX1 to a BB point. When Q2 and Q3 are turned on, and Q1 and Q4 are turned off, the resonant alternating current flows from the BB point of the transmitting coil TX1 to the AA point. By cyclically switching the conduction sequence of the four MOS transistors Q1, Q2, Q3, and A4 according to a certain frequency, an alternating magnetic field can be generated on the transmitting coil TX1, and the alternating magnetic field can provide wireless charging energy to an energy receiver.

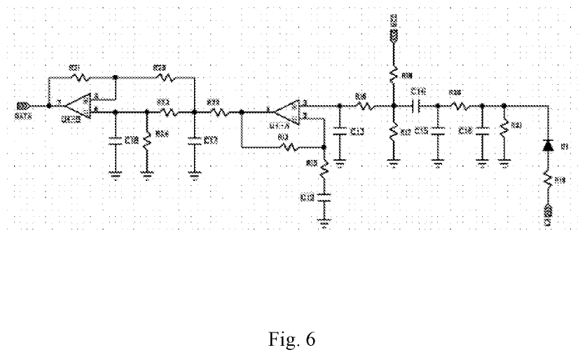

Referring to FIG. 6, the working principle of the communication protocol detecting module is as follows:

The communication protocol detecting module detects whether there is a suitable external device that needs to be charged wirelessly, which includes the following steps:
a) Detection phase: identifying a power supply device and foreign object debris (FOD).
b) Communication phase: performing identity authentication, enabling a transmitter to transmit a data packet, and supplying power for a receiver to start the receiver, and then responding by the receiver response data to complete the identity authentication.
c) Charging phase: performing power transmission; after identity authentication, selecting by the transmitter corresponding power and other parameters according to the device type of the receiver to charge the receiver.

The principle of the communication protocol detecting module is shown in FIG. 6 and its control mode is explained as follows: When there is FOD placed on a transmitting terminal of the wireless charging, this FOD will affect the alternating magnetic field, thus affecting the alternating current; and this current is connected to an I_Sens. pin of the wireless charging control module to determine if any FOD exists. When a standard device terminal is placed on the wireless transmitting terminal, a device terminal responds to a signal sent by the wireless transmitting terminal, and this response signal passes through the filtering and shaping circuit described above, and a response signal is output at a DATA terminal; the response signal is connected to a Data_In pin of the wireless charging control module, thus determining whether there is a device terminal that needs to be charged. If there is a device terminal that needs to be charged, it enters a wireless charging process. If there is no device terminal that needs to be charged, it enters an intermittent sleep process.

### Embodiment 2

This embodiment differs from Embodiment 1 in that:

A Bluetooth module is disposed in the make-up minor box, and the Bluetooth module is electrically connected to the main control module through a conversion module, and is mainly configured to implement Bluetooth connection control between a mobile phone and the make-up mirror box.

A charging port 12 for single-port USB charging and discharging is disposed on a side wall of the box bottom 1; the multi-level touch slider module comprises an arc-shaped touch slider 10 disposed on an outer ring of the inner auxiliary mirror 11; the button module comprises a wireless charging button 22 disposed on the outer top surface of the cover 2 and used for controlling wireless charging; and the output end of the wireless charging button 22 is electrically connected to the input end of the main control module.

The charging port 12 is based on a single-port USB charging and discharging technology, and the single-port USB charging and discharging technology refers to using only the same USB interface to complete the charging of a built-in battery of the product and using the built-in battery of the product to supply power to an external device (such as a mobile phone, a tablet computer, a video player, etc.) or/and charge the external device. The USB interface used by the product is a Micro USB socket, but not limited to the Micro USB socket, but also includes an ordinary USB socket, a MINT USB socket, a TYPE C USB socket, etc. When the USB interface of the product is connected to an external charger, the external charger will charge the built-in lithium ion battery of the product through the charging and discharging arbitration module and the charging management module. The charging current is limited to a range of 500 mA to 3000 mA. When the USB socket of the product is connected to an external product (such as a mobile phone, a tablet computer, a video player, etc.), the built-in lithium ion battery will supply power to the external product or/and charge the external product through the discharging management module and the charging and discharging arbitration module. The external output voltage of the product is 5V+/−0.5V and its output current is between 500 mA and 3000 mA.

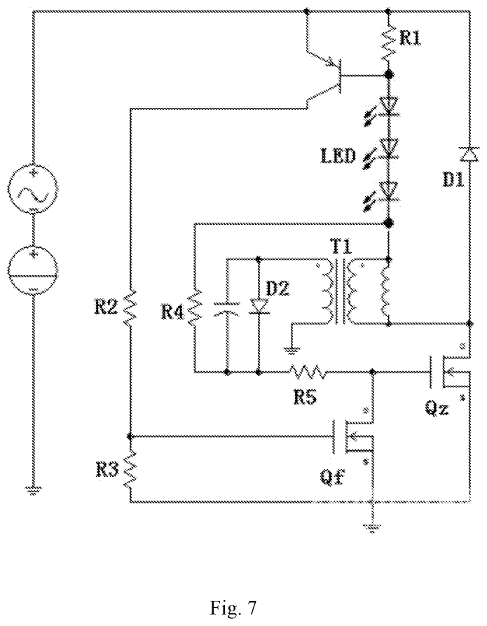

The power supply circuit of the fill light strip 21 is provided with an anti-flash circuit. For the specific principle of the anti-flash circuit, please refer to FIG. 7. By adjusting the parameters, it is found that a resistor R1 and an inductor T1 affect the switching frequency, a resistor R3 affects the constant current size and can control the peak current size, and valley current is affected by the input voltage.

The main mirror 20 and the inner auxiliary mirror 11 are arranged as magnifying lenses.

It is apparent to those skilled in the art that the invention is not limited to the details of the above-described exemplary embodiments, and the invention can be embodied in other specific forms without departing from the spirit or essential features of the invention. Therefore, from any point of view, the embodiments should be considered as illustrative and not restrictive. The scope of the invention is defined by the appended Claims rather than the description set forth above. All changes that fall within the meaning and scope of equivalents of the Claims are therefore intended to be included within the invention. Any reference signs in the Claims should not be construed as limiting the related Claims.

In addition, it should be understood that although the description is described in terms of embodiments, not every embodiment includes only one independent technical solution. What is disclosed in the description is merely for the sake of clarity, and those skilled in the art should regard the description as a whole. The technical solutions in the embodiments may also be combined as appropriate to form other embodiments that can be understood by those skilled in the art.

1. A charging make-up mirror that provides a ring-shaped and soft fill light devoid of flash, said charging make-up mirror comprising:
a make-up mirror box, wherein the make-up mirror box comprises:
a box bottom (1) and a cover (2) which are in hinged fit, and wherein the cover (2) and the box bottom (1) respectively have a built-in main mirror (20) and a built-in inner auxiliary mirror (11) which are opposite to each other;
a fill light strip (21) for providing the ring-shaped and soft fill light devoid of flash, wherein the fill light strip (21) is disposed around the main mirror (20) and comprises a beauty component, wherein the beauty component comprises an LED (24), a diffuse reflection lampshade (26), and a filter coating (28), wherein the LED (24) and the diffuse reflection lampshade (26) constitute a body of the fill light strip (21), wherein the diffuse reflection lamp shade (24) comprises an uneven inner surface configured to scatter light via a diffuse reflection to achieve a uniform light phenomenon for softening a contour of an object (face) viewed through the charging make-up mirror, with a reduced contrast, thereby producing a smooth and radiant view of the object devoid of flash; wherein the filter coating (28) is coated on an outer surface of the diffuse reflection lampshade, wherein the filter coating (28) filters out blue light and infrared light so that the light transmitted through the diffuse reflection lampshade (26) remains warm and soft, thereby preventing the object from appearing too blue or too red in the charging make-up mirror, and wherein at least one of the built-in main mirror (20) and the built-in inner auxiliary mirror (11) adopts a symmetrical design with a slight depression from the left and right sides to the center;
a multi-level touch slider module for adjusting the fill light strip (21) is disposed in the make-up mirror box; a power module for supplying power, a wireless charging module for charging an external smart device and the power module itself, and a main control module, all of which disposed inside the box bottom (1);
a cover opening/closing detecting module for detecting an open/closed state of the cover (2) and the box bottom (1) disposed in a position where the box bottom (1) and the cover (2) are hinged; and
a button module to be connected with the main control module disposed on a surface of the cover (2); wherein an input end of the main control module is electrically connected to output ends of the button module, the cover opening/closing detecting module and the multi-level touch slider module.

2. The charging make-up mirror according to claim 1, wherein the power module comprises a lithium ion rechargeable battery, a charging management module, a discharging management module, and a charging and discharging arbitration module, wherein the charging and discharging arbitration module is electrically connected to a charging end of the lithium ion rechargeable battery through the charging management module, a discharging end of the lithium ion rechargeable battery is electrically connected to the charging and discharging arbitration module through the discharging management module, and the discharging end of the lithium ion rechargeable battery is electrically connected to the main control module of the main control module and a power supply end of the wireless charging module through the power management module.

3. The charging make-up mirror according to claim 1, wherein the wireless charging module comprises a wireless charging driver module, a communication protocol detecting module, and a transmitting coil, a signal end of the wireless charging driver module is electrically connected to an output end of the main control module, a receiving end of the communication protocol detecting module is connected in parallel in a loop of the transmitting coil, and an output end of the communication protocol detecting module is electrically connected to an input end of the main control module.

4. The charging make-up mirror according to claim 1, wherein the multi-level touch slider module comprises a capacitive touch gradient-changing button disposed in the make-up mirror box, an output end of the touch gradient-changing button is electrically connected to the input end of the main control module, and the touch gradient-changing button comprises an arced gradient-changing button and a linear gradient-changing button, the touch area of the touch gradient-changing button is increased gradually or reduced gradually or first increased and then reduced, from an initial end to a terminal end.

5. (canceled)

6. The charging make-up mirror according to claim 1, wherein a short-range wireless communication module is disposed in the make-up mirror box, and the short-range wireless communication module is electrically connected to the main control module through a conversion module and is mainly configured to implement a short-range wireless connection control between a mobile phone and the make-up mirror box.

7. The charging make-up mirror according to claim 1, wherein a charging port (12) for single-port USB charging and discharging is disposed on a side wall of the box bottom (1); the multi-level touch slider module comprises an arc-shaped touch slider (10) disposed on an outer ring of the inner auxiliary mirror (11); the button module comprises a wireless charging button (22) disposed on the outer top surface of the cover (2) and used for controlling wireless charging; and the output end of the wireless charging button (22) is electrically connected to the input end of the main control module.

8. The charging make-up mirror according to claim 1, wherein a power loop of the fill light strip (21) is provided with an anti-flash circuit.

9. The charging make-up mirror according to claim 1, wherein the main mirror (20) and the inner auxiliary mirror (11) are arranged as magnifying lenses.
